(19) United States
(12) Patent Application Publication
(10) Pub. No.: US 2015/0049793 A1
(43) Pub. Date: Feb. 19, 2015

(54) INTERFACE SHARING BETWEEN DIGITAL AND RADIO FREQUENCY CIRCUITS

(71) Applicant: QUALCOMM Incorporated, San Diego, CA (US)

(72) Inventors: Faramarz Sabouri, San Diego, CA (US); Sunil Kumar Kandukuri Narayan, San Diego, CA (US); Vinod V. Panikkath, San Diego, CA (US); Seyed Aidin Bassam, San Diego, CA (US)

(73) Assignee: QUALCOMM Incorporated, San Diego, CA (US)

(21) Appl. No.: 13/969,413

(22) Filed: Aug. 16, 2013

(51) Int. Cl. H04L 27/20

(52) U.S. Cl. CPC H04L 27/2003
USPC 375/220

(57) ABSTRACT

Exemplary embodiments are related to interfacing a digital module and a radio-frequency (RF) module of a wireless communication device. A device may include a digital module configured to output at least one constant-envelope phase modulated signal. The device may further include an RF module configured to receive the at least one constant-envelope phase modulated signal and generate one or more digital bits in response to receipt of the at least one constant-envelope phase modulated signal.

### BACKGROUND

1. Field

The present invention relates generally to interfacing a digital module and a radio-frequency module of a wireless communication device.

2. Background

Wireless communication systems are widely deployed to provide various types of communication content such as voice, video, data, and so on. These systems may be multiple-access systems capable of supporting simultaneous communication of multiple wireless communication devices with one or more base stations.

A wireless communication device commonly incorporates multiple components. For example, a wireless communication device may include a power module, a digital module including one or more processors, and a radio-frequency (RF) module including one or more transceivers. As will be understood by a person having ordinary skill in the art, a baseband processor within a digital module may interface with one or more components of an RF module. The baseband processor may generate and convey baseband signals in digital format. Further, a transmitter within the RF module may receive the baseband signals from the baseband processor and up-convert the baseband signal to RF using one or more mixers. The transmitter may then amplify the RF signal, via a driver amplifier and power amplifiers, for transmission via an antenna.

In current RF transceivers, 1-3 digital interface pins are assigned to Global System for Mobile Communications (GSM) phase data, which is transmitted from digital module to an RF transceiver during operation in a GSM mode. Further, in low-tier markets, the reduction of die area is extremely important. In devices with wafer level package (WLP), the number of I/Os (pins) is limited by the die area. Therefore, pin reduction is of utmost importance

A need exists for reducing a number of pins within a wireless communication device. More specifically, a need exists for embodiments related to a digital to RF interface that enables a reduction of pins on each of a digital module and an RF module of a wireless communication device.

### BRIEF DESCRIPTION OF THE DRAWINGS

FIG. 1 illustrates a block diagram of a wireless communication device.

FIG. 2 shows an implementation of the wireless communication device illustrated in FIG. 1.

FIG. 3 illustrates a wireless communication device including a digital module coupled to an RF module via a digital interface.

FIG. 4 illustrates a communication device including a digital module coupled to a radio-frequency module, according to an exemplary embodiment of the present invention.

FIG. 5 depicts a communication device including a digital module coupled to a radio-frequency module via a plurality of digital-to-analog converters and a plurality of analog-to-digital converters, according to an exemplary embodiment of the present invention.

FIG. 6 is another illustration of a communication device including a digital module coupled to a radio-frequency module, in accordance with an exemplary embodiment of the present invention.

FIG. 7 illustrates a plot depicting input states of a digital-to-analog converter relative to output signals of the digital-to-analog converter using only MSB inputs.

FIG. 8 is a flowchart depicting a method, in accordance with an exemplary embodiment of the present invention.

FIG. 9 is a flowchart depicting another method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

As noted above, wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. A CDMA network may implement a radio technology such as Universal Terrestrial Radio Access (UTRA), cdma2000, etc. UTRA includes Wideband CDMA (WCDMA) and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA.

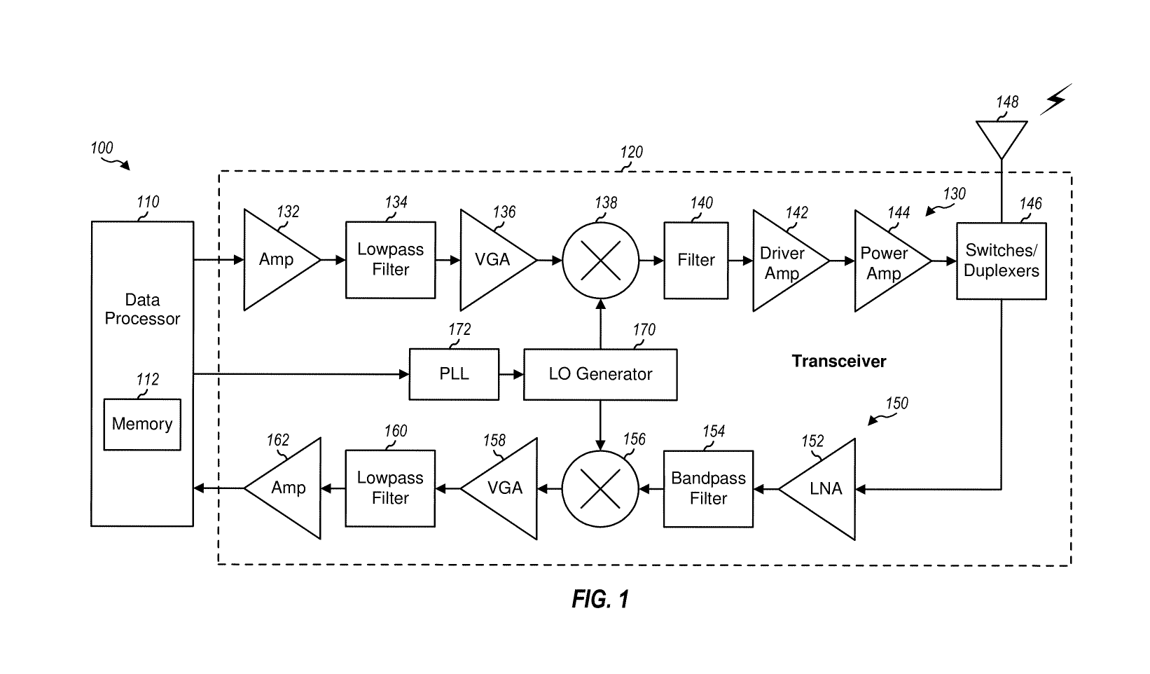

FIG. 1 shows a block diagram of an exemplary design of a wireless communication device 100. In this exemplary design, wireless device 100 includes a data processor 110 and a transceiver 120. Transceiver 120 includes a transmitter 130 and a receiver 150 that support bi-directional wireless communication. In general, wireless device 100 may include any number of transmitters and any number of receivers for any number of communication systems and any number of frequency bands.

In the transmit path, data processor 110 processes data to be transmitted and provides an analog output signal to transmitter 130. Within transmitter 130, the analog output signal is amplified by an amplifier (Amp) 132, filtered by a lowpass filter 134 to remove images caused by digital-to-analog conversion, amplified by a VGA 136, and upconverted from baseband to RF by a mixer 138. The upconverted signal is filtered by a filter 140, further amplified by a driver amplifier 142 and a power amplifier 144, routed through switches/duplexers 146, and transmitted via an antenna 148.

In the receive path, antenna 148 receives signals from base stations and/or other transmitter stations and provides a received signal, which is routed through switches/duplexers 146 and provided to receiver 150. Within receiver 150, the received signal is amplified by an LNA 152, filtered by a bandpass filter 154, and downconverted from RF to baseband by a mixer 156. The downconverted signal is amplified by a VGA 158, filtered by a lowpass filter 160, and amplified by an amplifier 162 to obtain an analog input signal, which is provided to data processor 110.

FIG. 1 shows transmitter 130 and receiver 150 implementing a direct-conversion architecture, which frequency converts a signal between RF and baseband in one stage. Transmitter 130 and/or receiver 150 may also implement a super-heterodyne architecture, which frequency converts a signal between RF and baseband in multiple stages. A local oscillator (LO) generator 170 generates and provides transmit and receive LO signals to mixers 138 and 156, respectively. A phase locked loop (PLL) 172 receives control information from data processor 110 and provides control signals to LO generator 170 to generate the transmit and receive LO signals at the proper frequencies.

FIG. 1 shows an exemplary transceiver design. In general, the conditioning of the signals in transmitter 130 and receiver 150 may be performed by one or more stages of amplifier, filter, mixer, etc. These circuits may be arranged differently from the configuration shown in FIG. 1. Furthermore, other circuits not shown in FIG. 1 may also be used in transmitter 130 and receiver 150. For example, matching circuits may be used to match various active circuits in FIG. 1. Some circuits in FIG. 1 may also be omitted. All or a portion of transceiver 120 may be implemented on one or more analog integrated circuits (ICs), RF ICs (RFICs), mixed-signal ICs, etc. For example, amplifier 132 through power amplifier 144 in transmitter 130 may be implemented on an RFIC. Driver amplifier 142 and power amplifier 144 may also be implemented on another IC external to the RFIC.

Data processor 110 may perform various functions for wireless device 100, e.g., processing for transmitted and received data. Memory 112 may store program codes and data for data processor 110. Data processor 110 may be implemented on one or more application specific integrated circuits (ASICs) and/or other ICs.

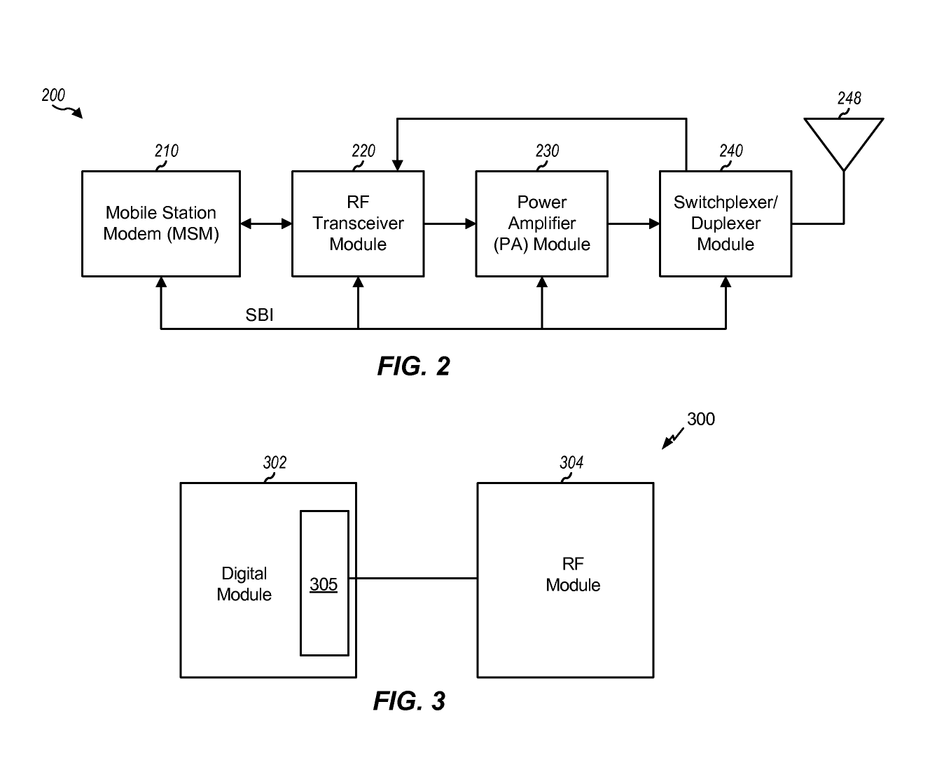

FIG. 2 shows a block diagram of an exemplary design of a wireless communication device 200, which may be one implementation of wireless communication device 100 in FIG. 1. In this exemplary design, wireless device 200 includes digital module 210, which may include a mobile station modem (MSM), an RF module 220, a power amplifier (PA) module 230, a switchplexer/duplexer module 240, and an antenna 248. Digital module 210 may include digital circuits (e.g., data processor 110 in FIG. 1) that can perform various functions for wireless device 100, e.g., processing for data transmission and reception. Digital module 210 may be an application specific integrated circuit (ASIC) commercially available from Qualcomm Incorporated or some other ASIC.

RF module 220 may include various circuits in a transceiver, e.g., all circuits in transceiver 120 in FIG. 1 except for power amplifier 144, switches/duplexers 146, and possibly driver amplifier 142. RF module 220 may be an RF integrated circuit (RFIC) commercially available from Qualcomm Incorporated or some other RFIC. PA module 230 may include power amplifier 144 and possibly driver amplifier 142 in FIG. 1. Switchplexer/duplexer module 240 may include switches/duplexers 146 in FIG. 1.

FIG. 3 illustrates a device 300 including a digital module 302 coupled to an RF module 304. As will be appreciated by a person having ordinary skill in the art, in conventional systems, digital module 302, which may comprise a MSM, may convey information (e.g., transmit signal phase data) to RF module 304, which may comprise a transceiver, via one or more dedicated pins (e.g., 1-3 pins) of a digital interface 305.

Exemplary embodiments, as described herein, are directed to devices and methods related to an interface between a digital module and an RF module of a device. According to one exemplary embodiment, a device may include a digital module configured to output at least one constant-envelope modulated (i.e., phase of frequency modulated) signal. As a more specific example, the digital module configured to output at least one analog signal comprising transmit signal phase information while operating in Global System for Mobile Communication (GSM) mode. The device may further include a RF module coupled to the digital module and configured to receive the at least one analog signal and generate one or more digital bits in response to receipt of the at least one analog signal.

According to another exemplary embodiment, the present invention includes methods for conveying transmit signal phase information from a digital module to an RF module. Various embodiments of such a method may include conveying at least one constant-envelope modulated (i.e., phase of frequency modulated) signal from the digital module to the RF module. As a more specific example, the method may include conveying at least one analog signal comprising phase information from a digital module while operating in Global System for Mobile Communication (GSM) mode. The method may also include receiving the at least one analog signal at the RF module. Further, the method may include generating one or more digital bits from the at least one analog signal at the RF module.

Other aspects, as well as features and advantages of various aspects, of the present invention will become apparent to those of skill in the art though consideration of the ensuing description, the accompanying drawings and the appended claims.

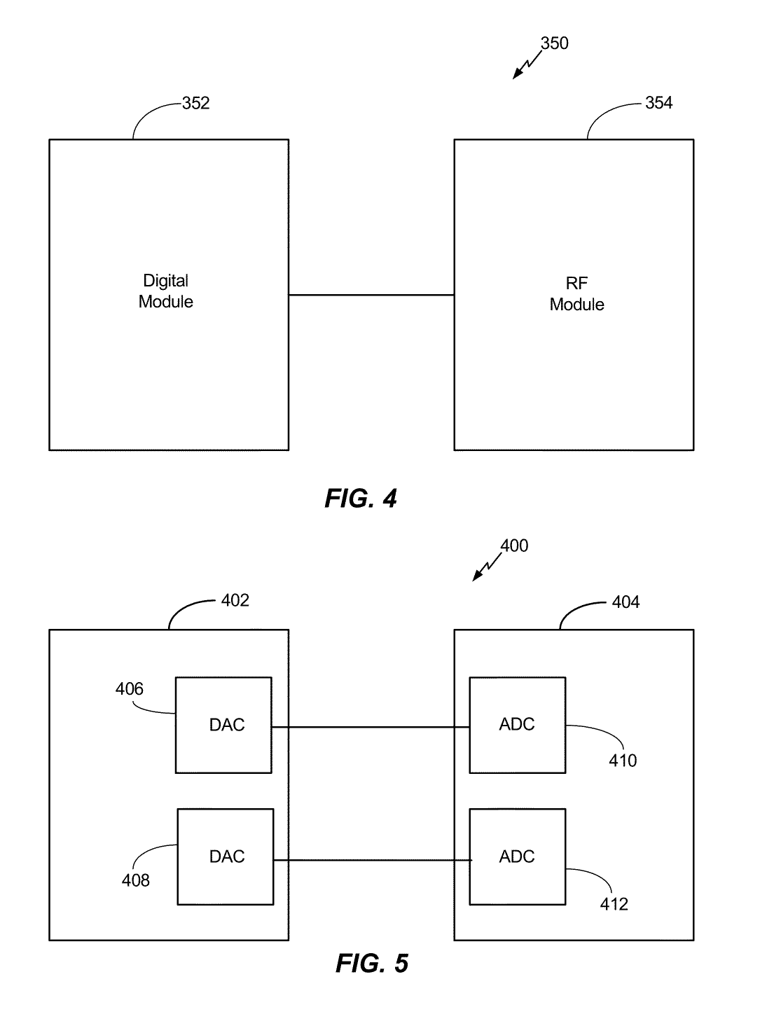

FIG. 4 illustrates a device 350, in accordance with an exemplary embodiment of the present invention. Device 350 includes a digital module 352 coupled to an RF module 354. By way of example only, digital module 352 may be part of an ASIC. Further, as an example, RF module 354 may comprise one or more RF transceivers and may be part of an RFIC. As will be understood by a person having ordinary skill in the art, digital module 352 may include a plurality of digital-to-analog converts (DACs) for conveying information to RF module 354. More specifically, during, for example, a GSM mode of operation, amplitude data of a transmit signal may be conveyed from digital module 352 to RF module 354 via a DAC.

In addition, a constant-envelope modulated (e.g., phase or frequency modulated) signal may be conveyed from digital module 352 to RF module 354 via another DAC. As a more specific example, while operating in GSM mode, phase data of the transmit signal may be conveyed from digital module 352 to RF module 354 via the another DAC. It is noted that the DAC used to convey the phase data may comprise a DAC that was previously unused (i.e., idle) (e.g., during conventional GSM operation). Accordingly, exemplary embodiments of the present invention may relate to sharing a DAC pin of digital module 352 for various operating modes (i.e., GSM, CDMA, etc.). Stated another way, for example only, a DAC pin, which was configured for use in a CDMA mode and idle during GSM operation, may now be used in both modes.

FIG. 5 depicts a device 400, according to an exemplary embodiment of the present invention. Device 400 includes a digital module 402, which includes a digital-to-analog converter (DAC) 406 and a DAC 408, and an RF module 404, which includes an analog-to-digital converter (ADC) 410 and ADC 412. As illustrated in FIG. 5, digital module 402 and RF module 404 are interfaced via DACs 406 and 408 and ADCs 410 and 412. More specifically, DAC 406 is configured to convey one or more analog signals to ADC 410 and DAC 408 is configured to convey one or more analog signals to ADC 412. According to one specific example, while in a GSM mode of operation, amplitude information of a transmit signal may be conveyed from DAC 406 to ADC 410 and phase information of the transmit signal may be conveyed from DAC 408 to ADC 412.

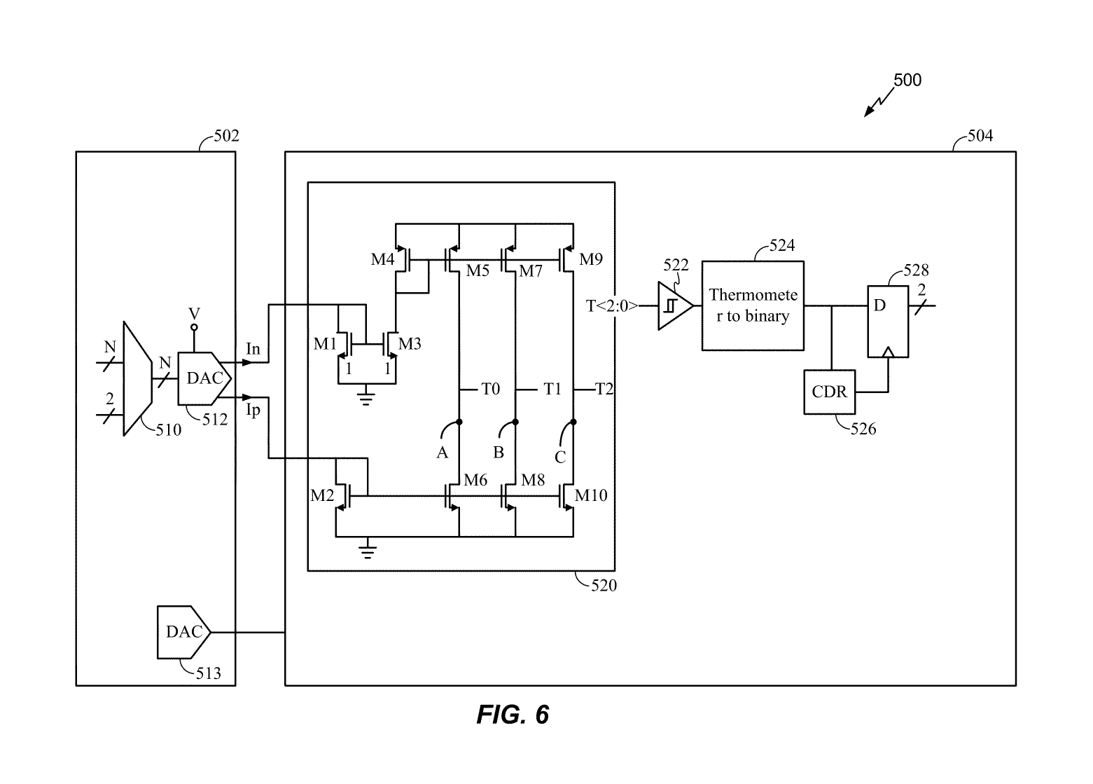

FIG. 6 is an illustration of a device 500, according to an exemplary embodiment of the present invention. Device 500, which may comprise device 400 illustrated in FIG. 5 and/or device 350 illustrated in FIG. 4, includes a digital module 502 and RF module 504. Further, digital module 502 may include a digital multiplexer (MUX) 510 and a DAC 512 having an input coupled to an output of digital MUX 510. Digital MUX 510 may be configured to receive phase information (i.e., of a transmit signal) and convey the phase information to an input of DAC 512. As will be understood, a DAC, such as DAC 512 may typically receive a plurality of bits (i.e., N bits).

In this exemplary embodiment, the two most significant bits of DAC 512 may receive the phase information and the remaining N−2 bits may be coupled to a ground voltage when phase information is being transmitted. Further, DAC 512 may receive the digital bits including the phase information and generate at least one analog signal including the phase information. More specifically, as one example, DAC 512 may output a differential analog output (i.e., signals Ip and In) having a value that changes based on the digital bits received at the input of DAC 512. It is noted that DAC 512 may comprise, for example only, a current DAC or a voltage DAC. In non-GSM mode, the same DAC 512 together with another DAC could be used for I/Q analog transmission.

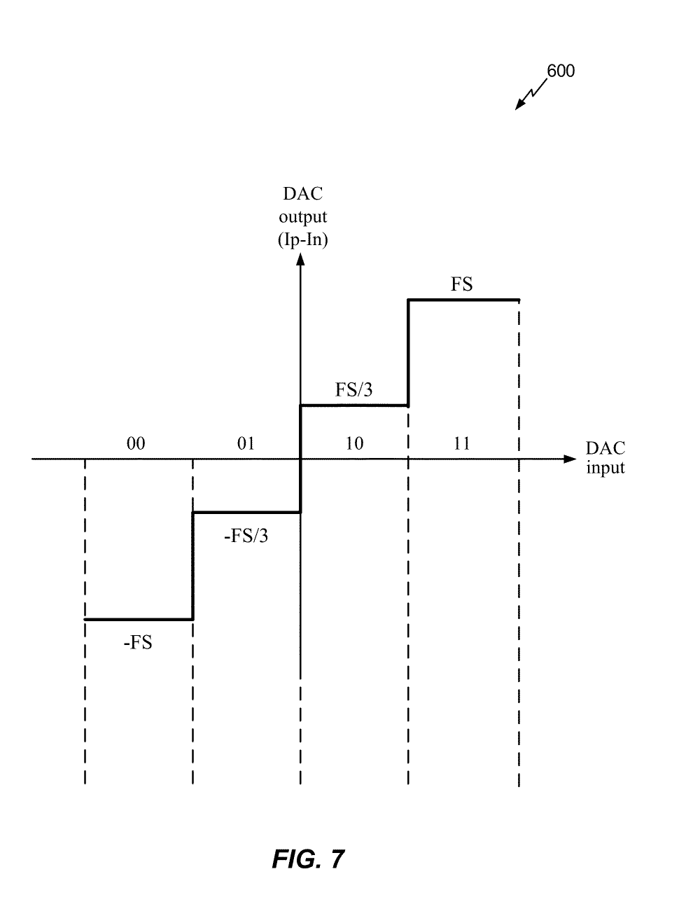

With reference to FIG. 7, a plot 600 illustrates four possible states for the input of DAC 512 (see FIG. 6) and corresponding analog output of DAC 512. As illustrated by plot 600, a DAC input of “00” provides an analog output of—full scale (FS). Stated another way, if the input of DAC 512 is “00”, the output of DAC 512 is—FS. Furthermore, for example, if the input of DAC 512 is “00”, signal Ip (see FIG. 6) may comprise a value of zero and signal In (see FIG. 6) may comprise a value of FS. In addition, a DAC input of “01” provides an output of—FS/3 (i.e., if the input of DAC 512 is “01”, the output of DAC 512 is —FS/3).

Also, for example, if the input of DAC 512 is “01”, signal Ip may comprise a value of

FS/3 and, signal In may comprise a value of (2/3)FS. Further, a DAC input of “10” provides an output of 2FS/3 (i.e., if the input of DAC 512 is “10”, the output of DAC 512 is FS*(2/3)). Furthermore, for example, if the input of DAC 512 is “10”, signal Ip may comprise a value of (2/3)FS, and signal In may comprise a value of FS/3. Moreover, a DAC input of “11” provides an output of FS (i.e., if the input of DAC 512 is “11”, the output of DAC 512 is FS). Additionally, for example, if the input of DAC 512 is “11”, signal Ip may comprise a value of FS, and signal In may comprise a value of zero.

Moreover, RF module 504, as illustrated in FIG. 6, may include an analog-to-digital converter (ADC) 520 configured to receive the differential output of DAC 512 and convey thermometer-coded output signals T0, T1, and T2. In addition, RF module 504 may also include a Schmitt trigger 522 configured to receive output signals T0, T2, and T2, removed noise from signals T0, T1, and T2 and, thereafter, convey output signals T0, T1, and T2 to a thermometer-to-binary converter 524. It is noted that ADC 520 is configured to produce different currents (i.e., three currents) proportional to an input current, and ADC 520 and Schmitt trigger 522 may collectively provide analog-to-digital conversion functionality.

Upon receipt of output signals T0, T1, and T2, thermometer-to-binary converter 524 may generate a binary representation of output signals T0, T1, and T2. For example, thermometer-to-binary converter 524 may generate a 2-bit binary representation of output signals T0, T1, and T2. More specifically, if a thermometer code for output signals T0, T1, and T2 is “000”, thermometer-to-binary converter 524 may generate a “00”. If a thermometer code for output signals T0, T1, and T2 is “001”, thermometer-to-binary converter 524 may generate a “01”. If a thermometer code for output signals T0, T1, and T2 is “011”, thermometer-to-binary converter 524 may generate a “10”. Further, if a thermometer code for output signals T0, T1, and T2 is “111”, thermometer-to-binary converter 524 may generate a “11”. RF module 504 may also include a clock data recovery circuit (CDR) 526 and a flip-flop 528. It is noted that CDR 526 may be configured to extract clock information from the received stream of bits. This clock information may then be used to re-synchronize the decoded binary bits.

As illustrated in the exemplary embodiment of FIG. 6, ADC 520 includes a plurality of transistors M1-M10. More specifically, ADC 520 includes a transistor M1 having a drain coupled to an analog signal In and a source coupled to a ground voltage GRND. Further a gate of transistor M1 is coupled to the drain of transistor M1 and a gate of a transistor M3. A source of transistor M3 is coupled to ground voltage GRND, and a drain of transistor M3 is coupled to a drain of a transistor M4, which is further coupled to a gate of transistor M4 and a gate of transistor M5. ADC also includes a transistor M2 having a drain coupled to an analog signal Ip and a source coupled to ground voltage GRND. A gate of transistor M2 is coupled to the drain of transistor M2.

A source of transistor M4 and a source of transistor M5 are coupled together, and a drain of transistor M5 is coupled to a drain of transistor M6. A first output signal TO may be conveyed at a node A coupled between the drain of transistor M5 and the drain of transistor M6. A source of transistor M6 is coupled to ground voltage GRND, and a gate of transistor M6 is coupled to a gate of transistor M2.

Further, ADC 520 includes a transistor M7 having a source coupled to a source of transistor M5, a gate coupled to a gate of transistor M5, and a drain coupled to a drain of a transistor M8. A second output signal T1 may be conveyed at a node B coupled between the drain of transistor M7 and the drain of transistor M8. A source of transistor M8 is coupled to ground voltage GRND, and a gate of transistor M8 is coupled to a gate of transistor M6. Additionally, ADC 520 includes a transistor M9 having a source coupled to a source of transistor M7, a gate coupled to a gate of transistor M7, and a drain coupled to a drain of a transistor M10. A third output signal T2 may be conveyed at a node C coupled between the drain of transistor M9 and the drain of transistor M10. A source of transistor M10 is coupled to ground voltage GRND, and a gate of transistor M10 is coupled to a gate of transistor M8. It is noted that FIG. 6 illustrates a non-limiting example implementation of a current-input flash ADC, and other implementations are within the scope of the present disclosure.

It is noted that digital module 502 may include at least one additional DAC 513. More specifically, during, for example only, GSM operation, additional transmit signal data (i.e., amplitude data) may be conveyed from digital module 502 to RF module 504 via DAC 513 of digital module 502.

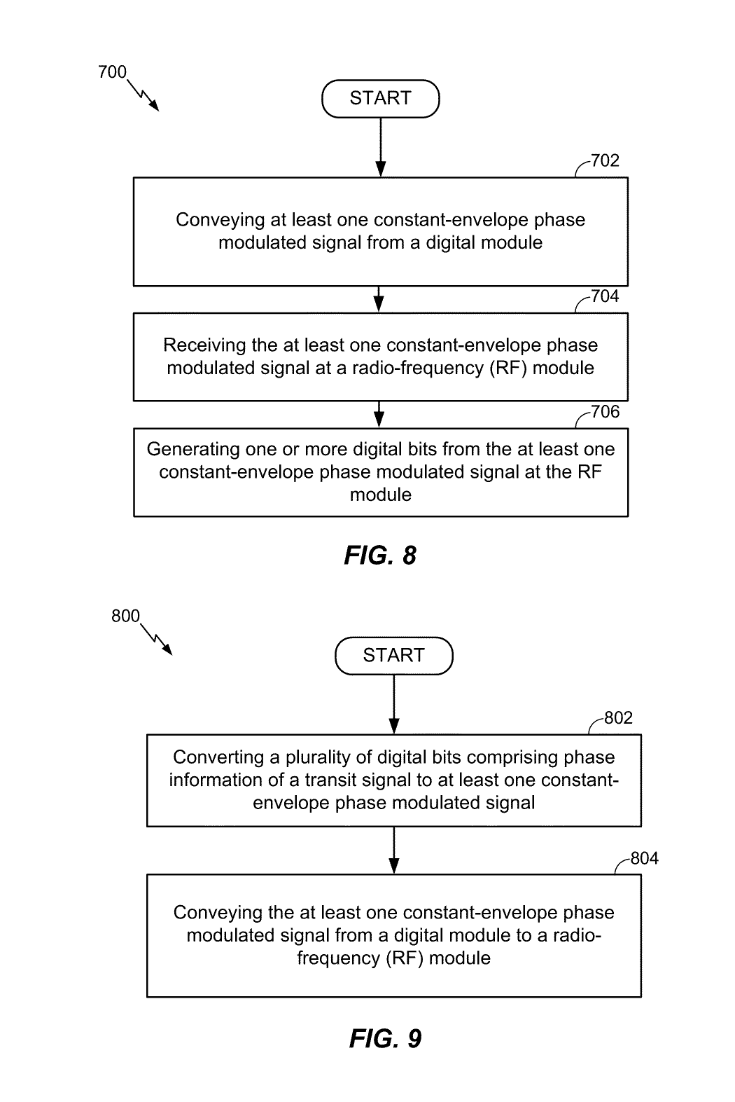

FIG. 8 is a flowchart illustrating a method 700, in accordance with one or more exemplary embodiments. Method 700 may include conveying at least one constant-envelope phase modulated signal from a digital module (depicted by numeral 702). As an example, the method may include conveying at least one analog signal comprising phase information from the digital module while operating in Global System for Mobile Communication (GSM) mode. Method 700 may also include receiving the at least one constant-envelope phase modulated signal at a radio-frequency (RF) module (depicted by numeral 704). Further, method 700 may include generating one or more digital bits from the at least one constant-envelope phase modulated signal at the RF module (depicted by numeral 706).

FIG. 9 is a flowchart illustrating a method 800, in accordance with one or more exemplary embodiments. Method 800 may include converting a plurality of digital bits comprising phase information of a transit signal to at least one analog signal (depicted by numeral 802). Method 800 may also include conveying the at least one analog signal comprising the phase information from a digital module to a radio-frequency (RF) module (depicted by numeral 804). By way of example, the at least one analog signal comprising the phase information may be conveyed from the digital module to the radio-frequency (RF) module while operating in Global System for Mobile Communication (GSM) mode.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another.

A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

1. A device comprising:
an input configured to receive at least one constant-envelope phase modulated signal from a digital module; and
circuitry configured to generate one or more digital bits based on the at least one constant-envelope phase modulated signal, the circuitry included in a radio-frequency (RF) module that includes a transceiver.

2. The device of claim 1, wherein the at least one constant-envelope phase modulated signal is based on two-bit Global System for Mobile Communication (GSM) phase information.

3. The device of claim 1, the circuitry comprising an analog-to-digital converter (ADC) configured to receive the at least one constant-envelope phase modulated signal and to generate the one or more digital bits.

4. The device of claim 3, the circuitry further comprising:
a Schmitt trigger coupled to an output of the ADC; and
a thermometer-to-binary converter coupled to an output of the Schmitt trigger,

5. The device of claim 4, the circuitry further comprising:
a flip-flop circuit coupled to an output of the thermometer-to-binary converter; and
a clock data recovery (CDR) circuit having a CDR input coupled to the output of the thermometer-to-binary converter and a CDR output coupled to the flip-flop circuit.

6. The device of claim 3, the ADC comprising a two-bit ADC.

7. The device of claim 1, the digital module comprising a digital-to-analog converter (DAC) configured to receive two-bit Global System for Mobile Communication (GSM) phase information and to output the at least one constant-envelope phase modulated signal based on the two-bit GSM phase information.

8. The device of claim 7, wherein the input is configured to receive information from the DAC based on a GSM mode and based on at least one other operating mode.

9. The device of claim 7, wherein the two most significant bit (MSB) inputs of the DAC are configured to receive the two-bit GSM phase information.

10. A method for signal transmission, the method comprising:
receiving, at a radio-frequency (RF) module, at least one constant-envelope phase modulated signal from a digital module; and
generating, at the RF module, one or more digital bits based on the at least one constant-envelope phase modulated signal, the RF module including a transceiver.

11. The method of claim 10, the receiving comprising receiving the at least one constant-envelope phase modulated signal from a digital-to-analog converter (DAC) of the digital module.

12. The method of claim 10, the receiving comprising receiving the at least one constant-envelope phase modulated signal at an analog-to-digital converter (ADC) of the RF module.

13. The method of claim 10, the generating comprising generating the one or more digital bits with an analog-to-digital converter (ABC), a Schmitt trigger, and a thermometer-to-binary converter.

14. The method of claim 10, the generating comprising converting a thermometer code to a two-bit binary representation.

15. (canceled)

16. The method of claim 10, wherein the at least one constant-envelope phase modulated signal comprises at least one analog signal based on two-bit Global System for Mobile Communication (GSM) phase information.

17. The method of claim 10, wherein the generating comprises generating the one or more digital bits with a two-bit analog-to-digital converter (ADC).

18. A device comprising:
means for receiving at least one constant-envelope phase modulated signal from a digital module; and
means for generating one or more digital bits based on the at least one constant-envelope phase modulated signal, the means for generating included in a radio-frequency (RF) module that includes a transceiver.

19. The device of claim 18, the means for generating comprising means for converting a thermometer code to a two-bit binary representation.

20. (canceled)

21. The device of claim 1, wherein the digital module and the RF module are integrated within different semiconductor dies.

22. The method of claim 10, further comprising upconverting, at the RF module, a frequency of at least one signal from a baseband frequency to a radio frequency.
